(19) United States
(12) Patent Application Publication
(10) Pub. No.: US 2018/0094335 A1
(43) Pub. Date: Apr. 5, 2018

(54) COOLING DEVICE FOR COOLING BULK MATERIAL

(71) Applicant: Primetals Technologies Austria GmbH, Linz (AT)

(72) Inventors: Michaela BOEBERL, St. Florian (AT); Ernst OBERNDORFER, Linz (AT); Andrea WEGERER, Walding (AT)

(21) Appl. No.: 15/571,991

(22) PCT Filed: May 4, 2016
(86) PCT No.: PCT/EP2016/059964

§ 371 Date: Nov. 6, 2017

(30) Foreign Application Priority Data
May 20, 2015 (EP) 15168305.9

(51) Int. Cl. C22B 1/26; B02C 1/02; B02C 23/20; F27D 15/02

(52) U.S. Cl. CPC C22B 1/26; F27D 15/0286; B02C 23/20; B02C 1/02

(57) ABSTRACT

A cooling device (2; 50) for cooling bulk goods (4), which has a cooling shaft (8) and at least one supply chute (14) for introducing the bulk goods (4) into the cooling shaft (8). To achieve uniform cooling of the bulk goods (4), the supply chute (14) has a first wall (30) and a second wall (32) arranged opposite the first wall (30). At least part of the first wall (30) is arranged at a different angle of inclination (34) with respect to a vertical line (36) than the second wall (32).

The invention relates to a cooling device for cooling bulk material, which has a cooling shaft and at least one supply chute for introducing the bulk material into the cooling shaft.

Hot bulk material, for example sintered iron ore from a sinter plant, generally has to be cooled before it can be stored in a silo and/or processed further.

In order to cool hot bulk material, it is known to use cooling devices of the abovementioned type (known as shaft coolers), in which the cooling shaft of the particular cooling device is used as heat exchanger. When cooling the bulk material, efforts are made to avoid uneven or spatially inhomogeneous cooling of the bulk material, although this is not usually successful with previously known cooling devices.

If the bulk material has regions which have only been cooled a little and are consequently at a high temperature, these regions can damage a conveyor connected downstream of the cooling device and/or a silo in which the bulk material is stored. Furthermore, in such a case, onward transport and/or further processing of the bulk material can be delayed since it is first necessary to wait until said regions of the bulk material have cooled to a sufficiently great extent.

It is an object of the invention to provide a cooling device for cooling bulk material, by means of which even cooling of the bulk material can be achieved.

This object is achieved by a cooling device of the type mentioned at the beginning, in which, according to the invention, the supply chute comprises a first wall and a second wall arranged opposite the first wall, and the first wall is arranged at least partially at a different inclination angle with respect to a vertical than the second wall, and the supply chute is mounted in a rotatable manner.

Advantageous developments of the cooling device according to the invention are the subject matter of the respective dependent claims and of the following description.

The invention proceeds from the consideration that large bulk material grains, in particular bulk material grains having a diameter of at least 80 mm, cool down more slowly than small bulk material grains. When the bulk material located in the cooling shaft has regions in which a concentration of large bulk material grains is above average, the bulk material cools down more slowly in these regions than in regions with an average or below-average concentration of large bulk material grains. In order that the bulk material can cool down evenly in the cooling shaft, it is thus advantageous for the bulk material grains to be distributed in a spatially homogeneous manner with regard to their size (or their diameter) in the cooling shaft.

Furthermore, the invention proceeds from the consideration that when the bulk material grains are introduced into the cooling shaft via the supply chute such that they are distributed in a spatially homogeneous manner, segregation of the bulk material grains with respect to their size can be avoided or reduced at least beneath the supply chute.

Moreover, the invention is based on the finding that since the first wall is arranged at least partially at a different inclination angle with respect to a vertical than the second wall, the bulk material grains are guided through the supply chute in a spatially homogeneous manner and are consequently also introduced into the cooling shaft in a spatially homogeneous manner. Said configuration of the supply chute therefore allows even cooling of the bulk material.

The bulk material can be for example sintered iron ore, also known as sinter. This means that the cooling device can be what is known as a sinter cooler.

Preferably, the second wall comprises a single wall portion that is configured in particular in a planar manner. In principle, however, it is possible for the second wall to have a plurality of wall portions. In the last-mentioned case, the individual wall portions of the second wall can be formed for example using a forming process. Alternatively, in the case of a plurality of wall portions, the second wall can have a plurality of wall panels which are connected together and which form the individual wall portions.

Furthermore, in the case in which the second wall has a plurality of wall portions, the first wall can be arranged at least partially at a different inclination angle with respect to a vertical than one of the wall portions of the second wall. Furthermore, in the case in which the second wall has a plurality of wall portions, the first wall can be arranged at least partially at a different inclination angle with respect to a vertical than a plurality, in particular all, of the wall portions of the second wall.

Preferably, the supply chute is arranged at least partially in the cooling shaft, in particular in an upper region of the cooling shaft.

Moreover, it is preferred for a distance between the two walls to decrease in an upward direction.

According to a preferred configuration of the invention, the first wall is arranged at an inclination angle of between 27° and 47° with respect to a vertical. In this case, the first wall appropriately has a single wall portion configured in particular in a planar manner. It is particularly advantageous for the first wall to be arranged at an inclination angle of between 34° and 40°, in particular at an inclination angle of 37°, with respect to a vertical. Furthermore, it is expedient for the second wall to be arranged at an inclination angle of between 7° and 27° with respect to a vertical. It is particularly advantageous for the second wall to be arranged at an inclination angle of between 14° and 20°, in particular at an inclination angle of 16.5°, with respect to a vertical. With such an arrangement or configuration of the two walls, segregation of the bulk material grains can be reduced particularly well.

In another preferred configuration of the invention, the second wall is arranged at an inclination angle of between 35° and 55° with respect to a vertical. It is particularly advantageous for the second wall to be arranged at an inclination angle of between 42° and 48°, in particular at an inclination angle of 45°, with respect to a vertical. Moreover, it is expedient for the first wall to have a first and a second wall portion. The first wall portion of the first wall can be in particular a lower wall portion, whereas the second wall portion of the first wall can be an upper wall portion. Preferably, the first wall portion of the first wall is arranged at an inclination angle of between 35° and 55° with respect to a vertical. It is particularly advantageous for the first wall portion of the first wall to be arranged at an inclination angle of between 42° and 48°, in particular at an inclination angle of 45°, with respect to a vertical. Furthermore, it is preferred for the second wall portion of the first wall to be arranged at an inclination angle of between 5° and 25° with respect to a vertical. It is particularly advantageous for the second wall portion of the first wall to be arranged at an inclination angle of between 8° and 14°, in particular at an inclination angle of 11°, with respect to a vertical. With such an arrangement or configuration of the two walls, segregation of the bulk material grains can be reduced particularly well.

In the case in which the first wall has a plurality of wall portions, the individual wall portions of the first wall can be formed for example using a forming process. Alternatively, the first wall can have a plurality of wall panels which are connected together and which form the individual wall portions.

Furthermore, it is preferred for the first wall portion of the first wall to be arranged at least substantially at the same inclination angle with respect to a vertical as the second wall. This means that the first wall portion of the first wall can be arranged parallel or substantially parallel to the second wall.

Appropriately, the supply chute comprises at least two further walls. Expediently, the two further walls are arranged opposite one another. In addition, it is expedient for the two further walls to each be connected to the first and/or the second wall.

Furthermore, the two further walls can be arranged parallel to one another. In particular, the two further walls can be arranged vertically.

In an alternative configuration of the invention, the two further walls can be arranged obliquely with respect to one another. In the last-mentioned case, a distance between the two further walls decreases preferably in a downward direction. Furthermore, it is preferred for the two further walls to be arranged at least substantially at the same inclination angle with respect to a vertical, for example at an inclination angle of 15°.

The supply chute expediently has a bulk material outlet. The bulk material outlet can comprise at least two ledges. Preferably, the ledges are oriented horizontally. Furthermore, it is expedient for the ledges to be positioned on different walls, in particular on walls arranged opposite one another. Furthermore, the ledges can each be a folded portion, in particular a portion folded at right angles, of the respective further wall. Furthermore, the ledges can be arranged at different heights.

Expediently, an accumulation of bulk material forms on each of the ledges. These accumulations of bulk material preferably serve to deflect at least some of the bulk material as it passes out of the supply chute, in particular to prevent the bulk material from passing out of the supply chute in a divergent manner. Furthermore, the accumulations of bulk material can reduce wear to or material abrasion of the supply chute.

Furthermore, the supply chute can have a rectangular cross-sectional shape, in particular in a horizontal cross section. Furthermore, it is advantageous for the supply chute to have, in horizontal cross section, a longitudinal extension which corresponds to 40% to 90% of an inside radius of the cooling shaft.

The supply chute is mounted in a rotatable manner. The supply chute can thus be what is known as a rotary chute. Moreover, the cooling device appropriately comprises a drive unit for driving or rotating the supply chute. As a result of a rotation of the supply chute, in particular with a constant rotation frequency, a radially symmetrical bulk material surface or a radially symmetrical bed height of the bulk material can be achieved in the cooling shaft. This in turn is advantageous for even cooling of the bulk material.

Furthermore, it is expedient for the cooling shaft to be configured at least partially in an axially symmetrical manner. The cooling shaft preferably comprises a shaft portion configured in a hollow-cylindrical manner. Expediently, a cylinder axis of the shaft portion configured in a hollow-cylindrical manner is oriented vertically.

In an advantageous configuration of the invention, the supply chute is mounted so as to be rotatable about the cylinder axis. Furthermore, the cylinder axis can be arranged outside the supply chute. In other words, the supply chute can be arranged such that the cylinder axis does not extend through the supply chute. Alternatively, the cylinder axis can be arranged inside the supply chute. This means that the supply chute can alternatively be arranged such that the cylinder axis extends through the supply chute.

Furthermore, the cooling device can have a collecting hopper. Expediently, the supply chute is connected to the collecting hopper, in particular connected on the input side.

Preferably, the cooling shaft is an air-cooled heat exchanger. Expediently, the cooling device comprises at least one fan, in particular a blower, for blowing cooling air into the cooling shaft. Furthermore, the cooling device can have at least one pump for evacuating cooling air out of the cooling shaft.

The cooling shaft can in particular be configured as what is known as a countercurrent heat exchanger. This means that the cooling air can flow through the cooling shaft in the opposite direction to a transport direction in which the bulk material is transported in the cooling shaft. As a result, it is possible to discharge more thermal energy from the bulk material to the cooling air than for example in the case of what is known as a cross current heat exchanger. In this way, a higher cooling air temperature can be achieved, with the result that more thermal energy can be made available, in turn, for subsequent processes which use the cooling air heated as it flows through the cooling shaft as a heat source. Appropriately, the bulk material is transported from top to bottom (under the force of gravity) in the cooling shaft. Accordingly, the cooling air preferably flows through the cooling shaft from bottom to top.

The heated cooling air can be used for example as a heat source for a sinter plant. Since the heated cooling air is fed to the sinter plant, it is also possible to avoid a situation in which waste heat from the cooling operation passes into the environment.

According to an advantageous development of the invention, the cooling device comprises a comminuting machine for comminuting bulk material grains. The comminution of the bulk material grains can comprise in particular crushing of the bulk material grains. Expediently, the comminuting machine is arranged on the input side of, in particular above, the supply chute. It is particularly preferred for the comminuting machine to be configured as a jaw crusher. The comminuting machine can furthermore be arranged on the input side of the abovementioned collecting hopper, in particular over the collecting hopper.

Since large bulk material grains cool down more slowly than small bulk material grains, it is possible, as a result of the comminution of the bulk material grains, for the bulk material grains to be cooled down to a lower temperature and at the same time for more thermal energy to be discharged to the cooling air from the bulk material grains. As a result of the greater cooling of the comminuted bulk material grains (with an unchanged dwell time in the cooling shaft), it is also possible to prevent a conveyor, on which the bulk material is discharged, from being damaged in the case of the bulk material grains breaking apart.

Furthermore, the cooling device can have a screen. Appropriately, the screen is arranged on the input side of the comminuting machine, in particular over the comminuting machine. The screen can be configured for example as a bar screen.

Furthermore, it is appropriate for the cooling device to comprise a conveyor belt, in particular an apron conveyor, for conveying the bulk material to the supply chute. Furthermore, provision can be made for the bulk material to be guided from the conveyor belt to the supply chute via the comminuting machine and/or via the collecting hopper.

Moreover, provision can be made for the cooling device to comprise at least one output device for discharging the bulk material from the cooling shaft. Appropriately, the output device is arranged beneath the cooling shaft, in particular immediately beneath the cooling shaft.

Furthermore, the cooling device can have a plurality of supply chutes, in particular a plurality of supply chutes of the above-described type. The supply chutes can be configured identically to one another. Furthermore, the supply chutes can be arranged at the same height. Moreover, the supply chutes can be arranged equidistantly from one another and/or in a radially regular manner. Furthermore, the supply chutes can be arranged at different radii, that is to say at different distances from the cylinder axis. Moreover, the supply chutes can be connected at least partially together, in particular connected together on the input side.

The description given thus far of advantageous configurations of the invention includes numerous features that are reproduced in the individual dependent claims, in some cases combined into groups. However, these features can expediently also be considered individually and combined into appropriate further combinations. In particular, these features can each be combined individually and in any suitable combination with the cooling device according to the invention. In addition, method features, worded in substantive terms, should also be considered properties of the corresponding device unit and vice versa.

Even though some terms are used in each case in the singular or in combination with a numeral in the description and/or in the claims, the scope of the invention is not intended to be limited to the singular or the respective numeral for these terms.

The characteristics, features and advantages of the invention that are described above and the manner in which they are achieved will be more clearly comprehensible in conjunction with the following description of the exemplary embodiments of the invention, which are explained in greater detail in conjunction with the drawings. The exemplary embodiments are used to explain the invention and do not limit the invention to the combinations of features, including functional features, that are specified therein. For this purpose, it is furthermore also possible for suitable features of each exemplary embodiment to be considered explicitly in isolation, removed from an exemplary embodiment, introduced into a different exemplary embodiment to supplement the latter, and combined with any one of the claims.

In the drawings:

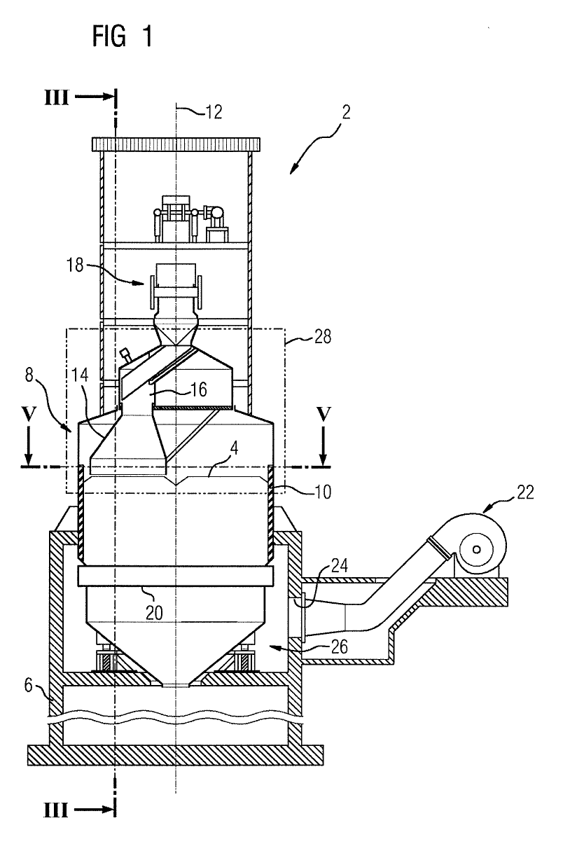

FIG. 1 shows a longitudinal section through a cooling device for cooling bulk material, which has, inter alia, a cooling shaft and a supply chute;

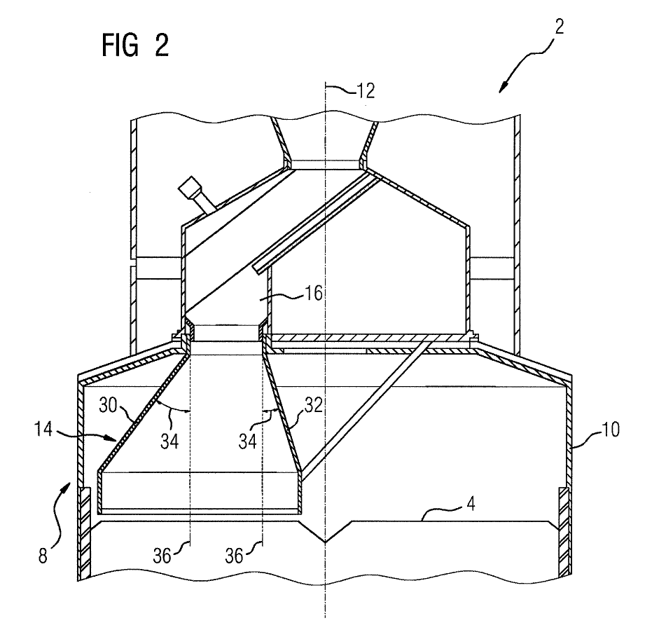

FIG. 2 shows an enlarged subregion of FIG. 1, in which the supply chute is depicted;

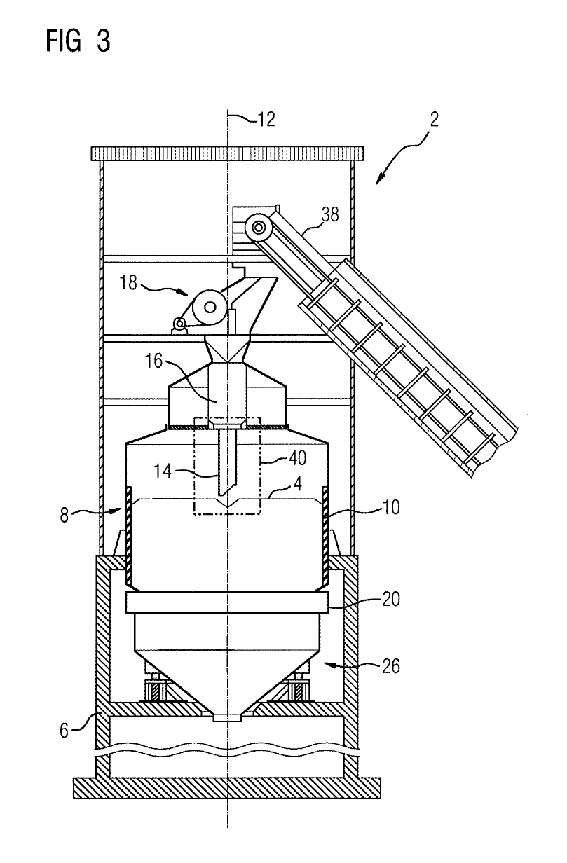

FIG. 3 shows another longitudinal section through the cooling device from FIG. 1 from a different perspective;

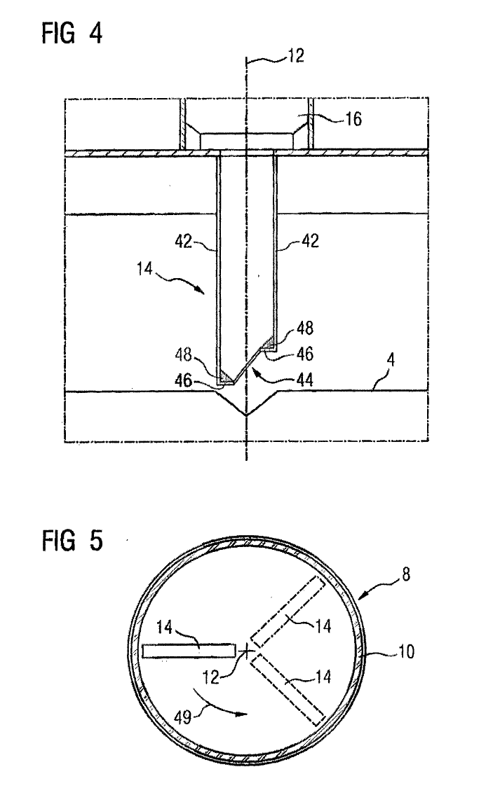

FIG. 4 shows an enlarged subregion of FIG. 3, in which the supply chute is depicted;

FIG. 5 shows a cross section through the cooling shaft of the cooling device;

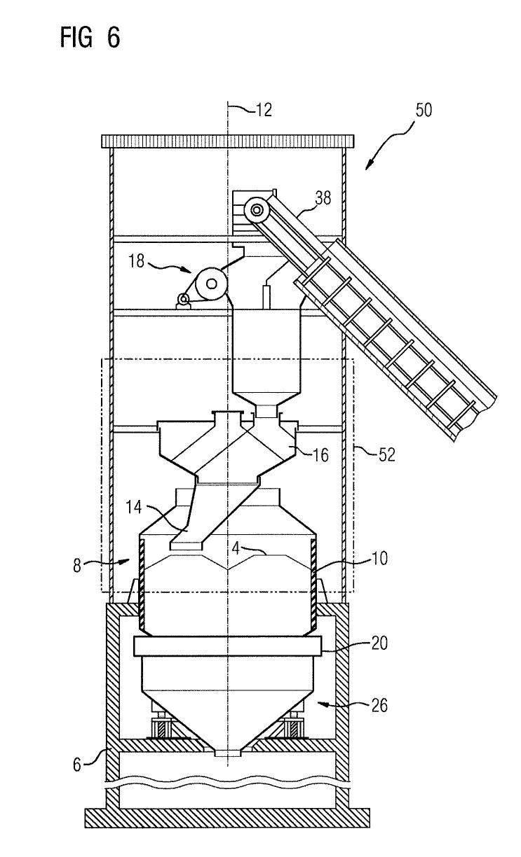

FIG. 6 shows a longitudinal section through a further cooling device for cooling bulk material, which has, inter alia, a cooling shaft and an alternative supply chute;

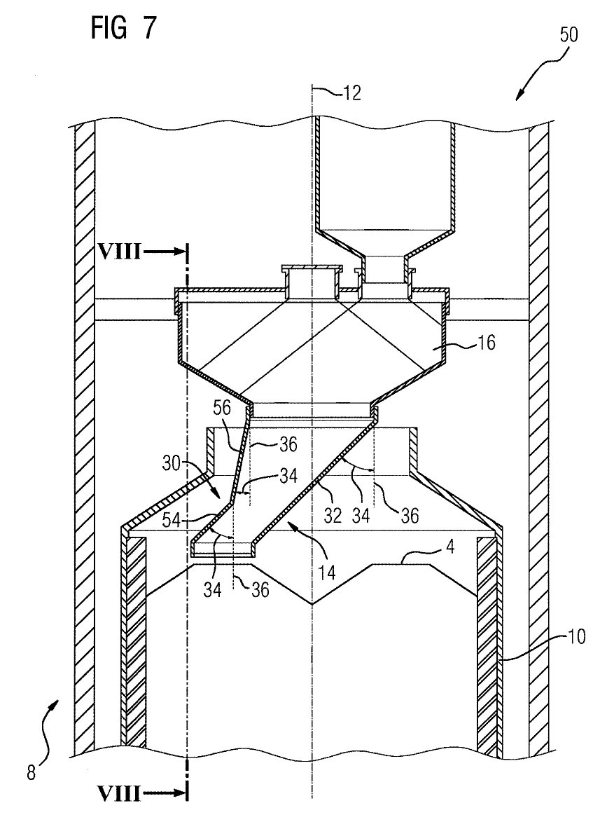

FIG. 7 shows an enlarged subregion of FIG. 6, in which the alternative supply chute is depicted; and

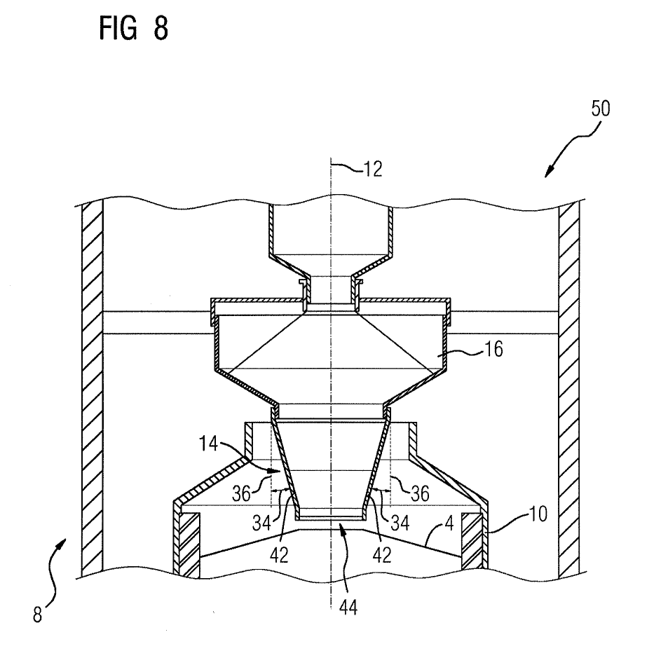

FIG. 8 shows a subregion of another longitudinal section through the further cooling device in FIG. 6 from a different perspective.

FIG. 1 shows a longitudinal section through an air-cooled cooling device 2 for cooling bulk material 4. The bulk material 4 consists of a multiplicity of bulk material grains. In the present exemplary embodiment, the bulk material 4 is sintered iron ore, also known as sinter. This means that the cooling device 2 is what is known as a sinter cooler.

The cooling device 2 comprises, inter alia, a construction 6 and also a cooling shaft 8 which rests on the construction 6. The cooling shaft 8 in turn comprises a shaft portion 10, configured in a hollow-cylindrical manner, with a vertically oriented cylinder axis 12 and is configured as a countercurrent heat exchanger.

Furthermore, the cooling device 2 comprises a supply chute 14 for introducing the bulk material 4 into the cooling shaft 8, said supply chute 14 being arranged in an upper portion of the cooling shaft 8. The supply chute 14 is mounted so as to be rotatable about the cylinder axis 12, wherein the cylinder axis 12 is arranged outside the supply chute 14, or does not extend through the supply chute 14.

Furthermore, the cooling device 2 comprises a collecting hopper 16 to which the supply chute 14 is connected on the input side. Moreover, the cooling device 2 has a comminuting machine 18, arranged above the collecting hopper 16, for comminuting or crushing bulk material grains, said comminuting machine 18 being configured as a jaw crusher.

The cooling device 2 additionally comprises an output device 20 for discharging the bulk material 4 from the cooling shaft 8, said output device 20 being arranged beneath the cooling shaft 8.

Moreover, the cooling device 2 is equipped with a fan 22 for blowing cooling air into the cooling shaft 8. The fan 22 has a cooling air outlet 24 which leads into a chamber 26 of the construction 6, the output device 20 and a lower portion of the cooling shaft 8 being arranged in said chamber 26.

Furthermore, a vertically oriented section plane III-III, parallel to the cylinder axis 12, to which FIG. 3 refers, and a horizontally oriented section plane V-V, to which FIG. 5 refers, are illustrated in FIG. 1. Furthermore, a subregion of the cooling device 2 is identified by a dot-dashed rectangle in FIG. 1, the following figure referring thereto.

FIG. 2 shows the subregion 28 from FIG. 1 in an enlarged illustration. The depicted subregion of the cooling device 2 shows the supply chute 14, the collecting hopper 16 and a part of the cooling shaft 8, in particular a part of the shaft portion 10 configured in a hollow-cylindrical manner.

It is apparent from FIG. 2 that the supply chute 14 has a first wall 30 and a second wall 32 arranged opposite the first wall 30, wherein the two walls 30, 32 are arranged at different inclination angles 34 with respect to a vertical 36. The first wall 30 is arranged at an angle of 37° with respect to a vertical 36, whereas the second wall 32 is arranged at an angle of 16.5° with respect to a vertical 36.

FIG. 3 shows a longitudinal section through the cooling device 2 along the section plane III-III in FIG. 1.

It is clear from the perspective in FIG. 3 that the cooling device 2 has, in addition to the above-described elements, a conveyor belt 38, in particular an apron conveyor, for conveying the bulk material 4 to the supply chute 14.

Furthermore, a subregion 40 of the cooling device 2 is identified by a dot-dashed rectangle in FIG. 3, the following figure referring thereto.

FIG. 4 shows the subregion 40 from FIG. 3 in an enlarged illustration. The depicted subregion of the cooling device 2 shows the supply chute 14 and a part of the collecting hopper 16.

It is apparent from FIG. 4 that the supply chute 14 comprises two further walls 42 which are arranged vertically and parallel to one another, wherein the two further walls 42 are arranged opposite one another and are connected to the two first-mentioned walls 30, 32.

It is also apparent from FIG. 4 that the supply chute 14 has a bulk material outlet 44 having two horizontal ledges 46. During operation of the cooling device 2, an accumulation of bulk material 48 forms on each of the two ledges 46. The accumulations of bulk material 48 deflect some of the bulk material emerging from the supply chute 14 as it emerges from the supply chute 14 and additionally reduce wear to the supply chute 14.

One of the two ledges 46 is arranged on one of the two further walls 42, while the other of the two ledges 46 is arranged on the other of the two further walls 42. Furthermore, the ledges 46 are arranged at different heights.

The hot bulk material 4 is conveyed with the aid of the conveyor belt 38 from a sinter plant (not illustrated in the figures) to the supply chute 14. Before the bulk material 4 passes into the supply chute 14, the bulk material grains are comminuted with the aid of the comminuting machine 18.

The comminuted bulk material 4 is guided into the collecting hopper 16, from where the bulk material 4 passes into the supply chute 14. By way of the supply chute 14, which rotates about the cylinder axis 12 at a constant rotation speed, the bulk material 4 is introduced into the cooling shaft 8.

On account of the shape of the supply chute 14, the bulk material grains pass into the cooling shaft 8 such that they are distributed in a spatially homogeneous manner (with regard to their grain diameter). In addition, a level bulk material surface in the cooling shaft 8 is achieved through the rotation of the supply chute 14.

With the aid of the fan 22, cooling air is blown into the abovementioned chamber 26 of the construction 6. The cooling air flows through the output device 20 and into the cooling shaft 8 and flows through the cooling shaft 8 from bottom to top. In the process, the cooling air absorbs thermal energy from the bulk material 4 such that the cooling air is heated up and at the same time the bulk material 4 is cooled down.

By means of the output device 20, the cooled bulk material 4 is discharged from the cooling shaft 8 in batches (portions).

Furthermore, the heated cooling air is evacuated from the cooling shaft 8 in an upper region of the cooling shaft 8 by means of pumps that are not illustrated in the figures, and is fed as a heat source to the sinter plant.

FIG. 5 shows a cross section through the cooling shaft 8, in particular through the shaft portion 10 configured in a hollow-cylindrical manner, along the section plane V-V in FIG. 1. The cross section illustrated is thus a horizontal cross section through the cooling shaft 8.

It is apparent from FIG. 5 that the supply chute 14 has a rectangular cross-sectional shape. In order to illustrate how the supply chute 14 rotates in the cooling shaft 8, a direction of rotation 50 of the supply chute 14 is depicted in FIG. 5, and the supply chute 14 is also depicted in three different, temporally successive positions.

The description of the following exemplary embodiment is limited substantially to the differences with regard to the above-described exemplary embodiment described in connection with FIG. 1 to FIG. 5, to which reference is made as far as features and functions that remain the same are concerned. Elements that are substantially identical or correspond to one another are denoted basically by the same reference signs and features that are not mentioned have been taken over to the following exemplary embodiment without being described again.

FIG. 6 shows a longitudinal section through a further air-cooled cooling device 50 for cooling bulk material 4. The present cooling device 50 has an alternative supply chute 14. Moreover, the further cooling device 50 has a cooling shaft 8 having a shaft portion 10 configured in a cylindrical manner.

The supply chute 14 of the further cooling device 50 is mounted so as to be rotatable about the cylinder axis 12 of the cylindrically configured shaft portion 10. However, the cylinder axis 12 is arranged inside the supply chute 14 in the present exemplary embodiment. This means that the cylinder axis 12 extends through the supply chute 14.

Furthermore, a subregion 52 of the cooling device 50 is identified by a dot-dashed rectangle in FIG. 6, the following figure referring thereto.

FIG. 7 shows the subregion 52 identified in FIG. 6 in an enlarged illustration.

It is apparent from FIG. 7 that the supply chute 14 of the further cooling device 50 comprises a first wall 30 and a second wall 32. These two walls 30, 32 are arranged opposite one another.

Furthermore, the first wall 30 has a first, lower wall portion 54 and a second, upper wall portion 56, wherein the first wall portion 54 is arranged at an inclination angle of 45° with respect to a vertical 36 and the second wall portion 56 is arranged at an inclination angle of 11° with respect to a vertical 36. Furthermore, the second wall 32 is arranged at an inclination angle of 45° with respect to a vertical 36. Consequently, the first wall portion 54 of the first wall 30 is arranged at the same inclination angle 34 with respect to a vertical 36 as the second wall 32. This means that the second wall 32 and the first wall portion 54 of the first wall 30 are arranged parallel to one another.

Furthermore, in the present exemplary embodiment, as a result of the rotation of the supply chute 14, rather than a level bulk material surface, a bulk material surface which is M-shaped (in the longitudinal section illustrated) is achieved.

Furthermore, FIG. 7 illustrates a vertically oriented section plane VIII-VIII that is parallel to the cylinder axis 12, the following figure referring thereto.

FIG. 8 shows a longitudinal section through the further cooling device 50 along the section plane VIII-VIII in FIG. 7.

In FIG. 8, it is apparent that the supply chute 14 of the further cooling device 50 has two further walls 42. The further walls 42 are arranged obliquely with respect to one another, wherein their distance apart decreases in a downward direction. Furthermore, the two further walls 42 are arranged at the same inclination angle 34, namely at an inclination angle of 15°, with respect to a vertical 36.

In contrast to the preceding exemplary embodiment, the supply chute 14 of the further cooling device 50 has a bulk material outlet 44 without ledges. In principle, such ledges (as described in connection with FIG. 4) would also be conceivable at the bulk material outlet 44 of the further cooling device 50.

Although the invention has been described and illustrated in more detail by way of the preferred exemplary embodiments, the invention is not limited by the disclosed example and other variations can be derived therefrom without departing from the scope of protection of the invention.

### LIST OF REFERENCE SIGNS

2 Cooling device

4 Bulk material

6 Construction

8 Cooling shaft

10 Shaft portion

12 Cylinder axis

14 Supply chute

16 Collecting hopper

18 Comminuting machine

20 Output device

22 Fan

24 Cooling air outlet

26 Chamber

28 Subregion

30 Wall

32 Wall

34 Inclination angle

36 Vertical

38 Conveyor belt

40 Subregion

42 Wall

44 Bulk material outlet

46 Ledge

48 Accumulation of bulk material

50 Cooling device

52 Subregion

54 Wall portion

56 Wall portion

1. A cooling device for cooling bulk material, comprising:
a cooling shaft;
at least one supply chute located and configured for introducing the bulk material into the cooling shaft;
the supply chute is comprised of a first wall and a second wall arranged opposite the first wall, the first wall is arranged at least partially at a first inclination angle with respect to a vertical and the second wall, is at a different inclination angle with respect to the vertical; and
the supply chute is mounted in a rotatable manner above the cooling shaft.

2. The cooling device as claimed in claim 1, wherein the first wall is arranged at an inclination angle of between 27° and 47° with respect to the vertical and the second wall is arranged at an inclination angle of between 7° and 27° with respect to the vertical.

3. The cooling device as claimed in claim 1, wherein the second wall is arranged at an inclination angle of between 35° and 55° with respect to the vertical;
the first wall has a first, lower wall portion and a second, upper wall portion;
wherein the first wall portion is arranged at an inclination angle of between 35° and 55° with respect to the vertical and the second wall portion is arranged at an inclination angle of between 5° and 25°, with respect to the vertical.

4. The cooling device as claimed in claim 3, the first wall portion of the first wall is arranged at the same inclination angle with respect to the vertical as the second wall.

5. The cooling device as claimed in claim 1, wherein the supply chute comprises at least two further walls arranged opposite one another and each further wall is connected to the first and the second wall.

6. The cooling device as claimed in claim 5, wherein the two further walls are arranged parallel to one another.

7. The cooling device as claimed in claim 5, wherein the two further walls are arranged obliquely with respect to one another, such that a distance between the two further walls decreases in a downward direction, and each of the two further walls is arranged at the same inclination angle with respect to the vertical.

8. The cooling device as claimed in claim 1, wherein the supply chute has a bulk-material outlet and at least two horizontally arranged ledges located toward the outlet and extending into the supply chute.

9. The cooling device as claimed in claim 1, wherein the supply chute has a rectangular cross-sectional shape in a horizontal cross section.

10. The cooling device as claimed in claim 1, further comprising the cooling shaft comprises a shaft portion configured as a hollow cylinder having a vertically oriented cylinder axis about which the supply chute is mounted in a rotatable manner.

11. The cooling device as claimed in claim 1, further comprising:
a collecting hopper having an input side and the supply chute is connected on the input side of the hopper.

12. The cooling device as claimed in claim 1, further comprising at least one fan located and operable for blowing cooling air into the cooling shaft.

13. The cooling device as claimed in claim 11, further comprising a comminuting machine, arranged on the input side of the supply chute, for comminuting bulk material grains, wherein the comminuting machine is configured as a jaw crusher.

14. The cooling device as claimed in claim 1, further comprising at least one output device located and configured for discharging the bulk material from the cooling shaft, the output device being arranged beneath the cooling shaft.
